(19) United States
(12) Patent Application Publication
(10) Pub. No.: US 2026/0027845 A1
(43) Pub. Date: Jan. 29, 2026

(54) DETECTION SYSTEM AND INKJET RECORDING APPARATUS

(71) Applicant: KYOCERA Document Solutions Inc., Osaka (JP)

(72) Inventor: Masahiko MIZUNO, Osaka (JP)

(73) Assignee: KYOCERA Document Solutions Inc., Osaka (JP)

(21) Appl. No.: 19/278,328

(22) Filed: Jul. 23, 2025

(30) Foreign Application Priority Data
Jul. 24, 2024 (JP) 2024-118375

(51) Int. Cl. B41J 25/308; B41J 11/00

(52) U.S. Cl. CPC B41J 25/308; B41J 11/0095

(57) ABSTRACT

A detection system includes a detection target device, a detection device, and a control part. The detection target device is provided with a first rotating member rotating around a first shaft. The detection device is provided with a second rotating member rotating around a second shaft by a driving force transmitted from the first rotating member through a gear train, and its output value monotonically increases or decreases according to a rotation angle of the second rotating member. The control part calculates a driving amount of the first rotating member for correcting an output value of the detection device from a phase shift of an output value of the detection device when a rotation direction of the first rotating member is changed.

### INCORPORATION BY REFERENCE

This application is based on and claims the benefit of priority from Japanese patent application No. 2024-118375 filed on Jul. 24, 2024, which is incorporated by reference in its entirety.

### TECHNICAL FIELD

The present disclosure relates to a detection system and an inkjet recording apparatus.

### BACKGROUND

In order to obtain a good image quality in an inkjet recording apparatus, it is necessary to optimize a gap between a conveyed sheet and an inkjet head. Therefore, a technique for adjusting the gap according to a thickness of the sheet has been studied. For example, there is a configuration in which the position of the sheet is detected by a sensor and the gap between the sheet and the inkjet head is adjusted based on the position of the sheet.

Incidentally, as a means for adjusting the gap, it is conceivable that the inkjet head is supported via a stepped member corresponding to various sheet thicknesses, and the height of the inkjet head is changed by sliding the stepped member. In this case, the proper gap can be guaranteed by confirming the operating amount of the stepped member, but it is necessary to improve the accuracy of detecting the operating amount in order to correspond to the sheets of various thicknesses. For example, in a configuration in which the operating amount is detected from a rotatable stepped member via a gear train, there is a problem that detection accuracy is lowered due to backlash of the gear train.

### SUMMARY

A detection system according to the present disclosure includes a detection target device, a detection device, and a control part. The detection target device is provided with a first rotating member rotating around a first shaft. The detection device is provided with a second rotating member rotating around a second shaft by a driving force transmitted from the first rotating member through a gear train, and its output value monotonically increases or decreases according to a rotation angle of the second rotating member. The control part calculates a driving amount of the first rotating member for correcting an output value of the detection device from a phase shift of an output value of the detection device when a rotation direction of the first rotating member is changed.

An inkjet recording apparatus according to the present disclosure includes a head unit which includes one or more inkjet heads and is in contact with the adjustment member, and the detection system. The control part controls the detection target device according to an operating amount of the detection target device detected by the detection system.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an external appearance of an image forming system according to one embodiment of the present disclosure.

FIG. 2 is a front view schematically showing an internal structure of an inkjet recording apparatus according to the embodiment of the present disclosure.

FIG. 3 is a perspective view of a head unit according to the embodiment of the present disclosure.

FIG. 4 is a perspective view of the head unit according to the embodiment of the present disclosure.

FIG. 5 is a perspective view showing an adjustment device according to the embodiment of the present disclosure.

FIG. 6 is a perspective view showing a gap adjustment device according to the embodiment of the present disclosure.

FIG. 7 is a perspective view showing a first rotating member, a ball, and a retainer according to the embodiment of the present disclosure.

FIG. 8 is a perspective view showing the first rotating member and the ball according to the embodiment of the present disclosure.

FIG. 9 is a perspective view showing the first rotating member according to the embodiment of the present disclosure.

FIG. 10 is a cross-sectional view taken along the line I-I of FIG. 6.

FIG. 11 is a plan view showing the first rotating member according to the embodiment of the present disclosure.

FIG. 12 is a cross-sectional view taken along the line II-II of FIG. 11.

FIG. 13 is a perspective view of a detection system according to the embodiment of the present disclosure.

FIG. 14 is a diagram showing an operation of the detection system while the first rotating member rotates once.

FIG. 15 is a diagram showing the operation of the detection system while the first rotating member rotates 1/N (N=3).

FIG. 16 is a diagram showing a phase shift due to backlash when the rotational direction of the first rotating member is changed.

### DETAILED DESCRIPTION

Hereinafter, with reference to the drawings, a detection system 200 and an inkjet recording apparatus 1 according to one embodiment of the present disclosure will be described.

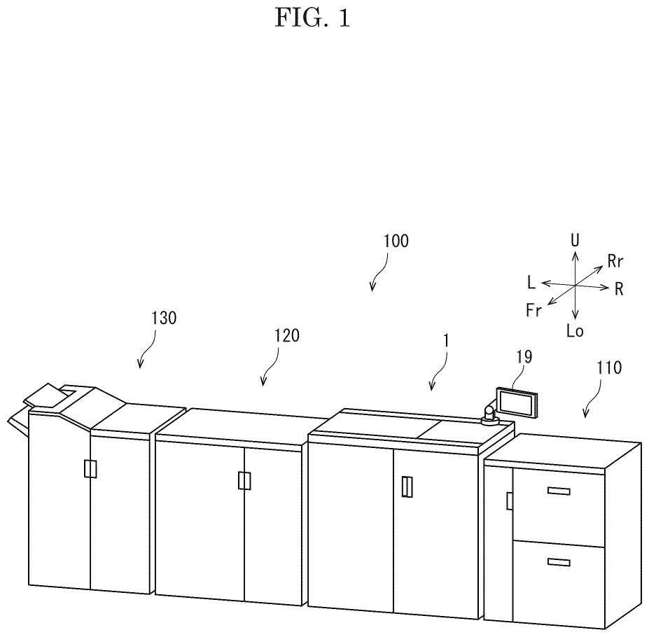

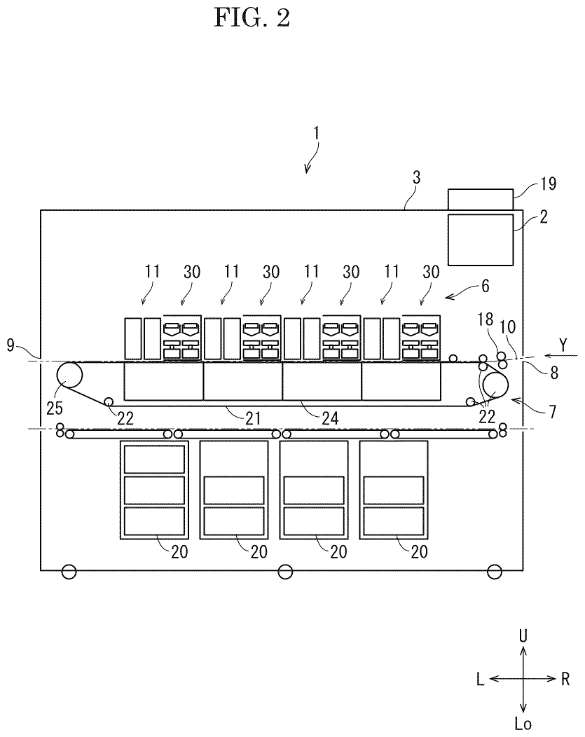

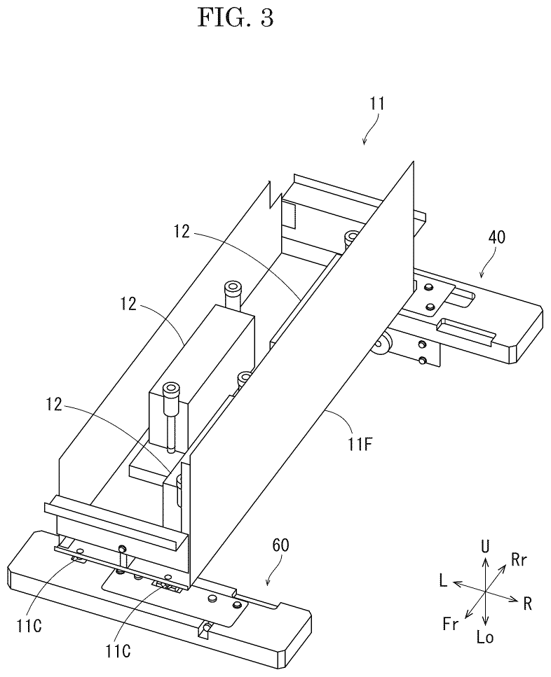

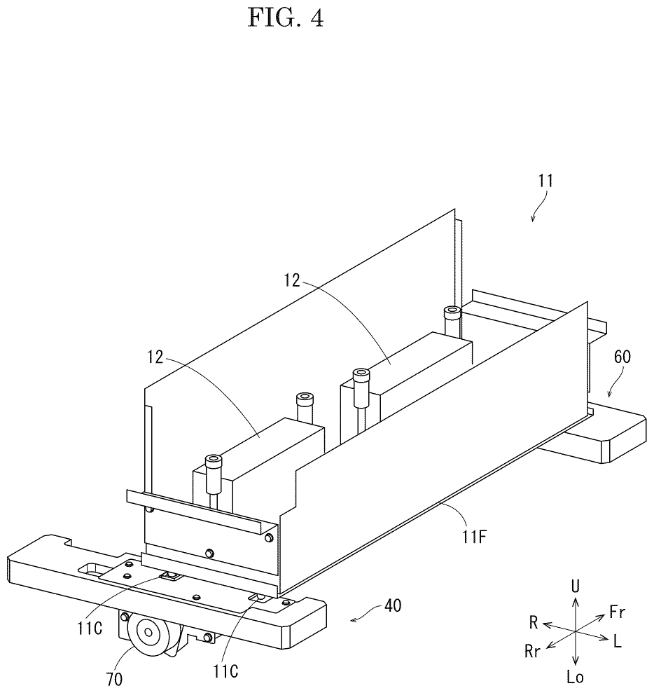

FIG. 1 is a perspective view showing an external appearance of the image forming system 100. FIG. 2 is a front view schematically showing the internal structure of the inkjet recording apparatus 1. FIG. 3 and FIG. 4 are perspective views showing a head unit 11. Hereinafter, the front side of the paper plan on which FIG. 2 is drawn is defined as the front side of the inkjet recording apparatus 1, and the left-and-right direction is described with reference to the direction in which the inkjet recording apparatus 1 is viewed from the front side. In each figure, U, Lo, L, R, Fr, and Rr indicate the upper, lower, left, right, front, and rear, respectively.

The image forming system 100 (see FIG. 1) includes a sheet feeding apparatus 110, the inkjet recording apparatus 1, a drying apparatus 120, and a post-processing apparatus 130. The sheet feeding apparatus 110 stores several thousand sheets, and feeds the sheets to the inkjet recording apparatus 1. The inkjet recording apparatus 1 forms an image on the sheet by an inkjet system. The drying apparatus 120 heats and dries the ink ejected on the sheet. The post-processing apparatus 130 performs such post-processing as perforating, staple binding, and folding on the sheet.

The inkjet recording apparatus 1 (see FIG. 2) includes a rectangular parallelepiped body housing 3. A conveying unit 7 which attracts and conveys the sheet in the Y direction is provided in the central portion of the body housing 3. An image forming unit 6 which forms an image by ejecting ink is provided above the conveying unit 7. A sheet feeding port 8 through which the sheet is introduced from the sheet feeding apparatus 110 is provided on the right side surface of the body housing 3. A discharge port 9 through which the sheet on which the image is formed is discharged to the drying apparatus 120 is provided on the left side surface of the body housing 3. Inside the body housing 3, a conveyance path 10 extending from the sheet feeding port 8 to the discharge port 9 through a gap between the conveying unit 7 and the image forming unit 6 is provided. A registration roller 18 is provided on the upstream side of the conveying unit 7 in the conveyance direction Y.

The conveying unit 7 includes an endless conveying belt 21 and a suction part 24. The conveying belt 21 has a large number of air-holes (not shown), and is wound around a driving roller 25 and a driven roller 22. The upper surface of the suction part 24 has a large number of air-holes (not shown), and is in contacts with the inner surface of the conveying belt 21. The suction part 24 sucks air through the air-holes of the conveying belt 21 and the air-holes of the suction part 24, so that the sheet is attracted to the conveying belt 21. The driving roller 25 is driven in the counterclockwise direction by a drive unit (not shown) including a motor and a reduction gear, whereby the conveying belt 21 is traveled in the counterclockwise direction, and the sheet attracted by the conveying belt 21 is conveyed.

The image forming unit 6 includes a plurality of (in this embodiment, four) of head units 11. The head unit 11 (see FIG. 3 and FIG. 4) includes one or more inkjet heads 12 (in this embodiment, three inkjet heads arranged in a staggered pattern). Ink containers 20 filled with the black, cyan, magenta, and yellow inks are connected to the four head units 11. A maintenance device 30 for performing maintenance of the inkjet head 12 is provided on the right side of each head unit 11.

A control part 2 (see FIG. 2) includes an arithmetic part and a storage part (not shown). The arithmetic part is, for example, a CPU (Central Processing Unit). The storage part includes a storage medium such as ROM (Read Only Memory), RAM (Random Access Memory), and EEPROM (Electrically Erasable Programmable Read Only Memory). The arithmetic part reads and executes control program stored in the storage part to perform various processes. The control part 2 may be implemented by an integrated circuit that does not use software.

A display operation part 19 is provided on the upper portion of the body housing 3 (see FIG. 1 and FIG. 2). The display operation part 19 includes a display panel, a touch panel laminated on the display panel, and a keypad (not shown). The control part 2 displays a screen showing an operation menu, a status or the like of the inkjet recording apparatus 1 on the display panel, and controls each part of the inkjet recording apparatus 1 according to the operation detected by the touch panel and the keypad.

The basic image forming operation of the inkjet recording apparatus 1 is as follows. When an image forming job is input to the inkjet recording apparatus 1 from the display operation part 19 or an external computer, the sheet feeding apparatus 110 feeds the sheet to the conveyance path 10 through the sheet feeding port 8, and the registration roller 18 whose rotation is stopped corrects the skew of the sheet. When the registration roller 18 feeds the sheet to the conveying unit 7 at a predetermined timing, the conveying unit 7 attracts the sheet to the conveying belt 21 and conveys the sheet in the Y direction. The ink is ejected from a nozzle to form an image on the sheet. The sheet on which the image is formed is discharged to the drying apparatus 120 through the discharge port 9.

[Adjustment Device] The rear end portion and the front end portion of the head unit 11 are supported by an adjustment device 40 and an adjustment device 60, respectively (see FIG. 3 and FIG. 4). The adjustment devices 40 and 60 have a function of adjusting the position of the head unit 11 in the upper-and-lower direction.

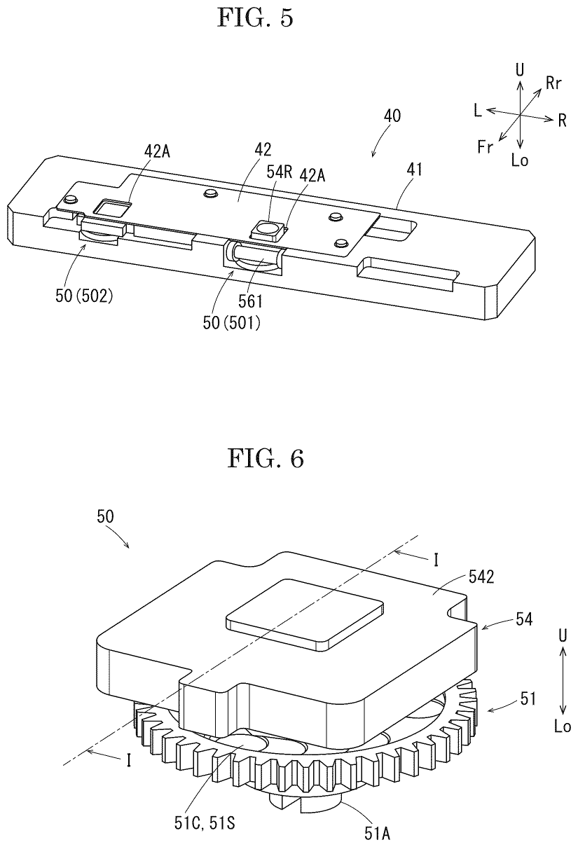

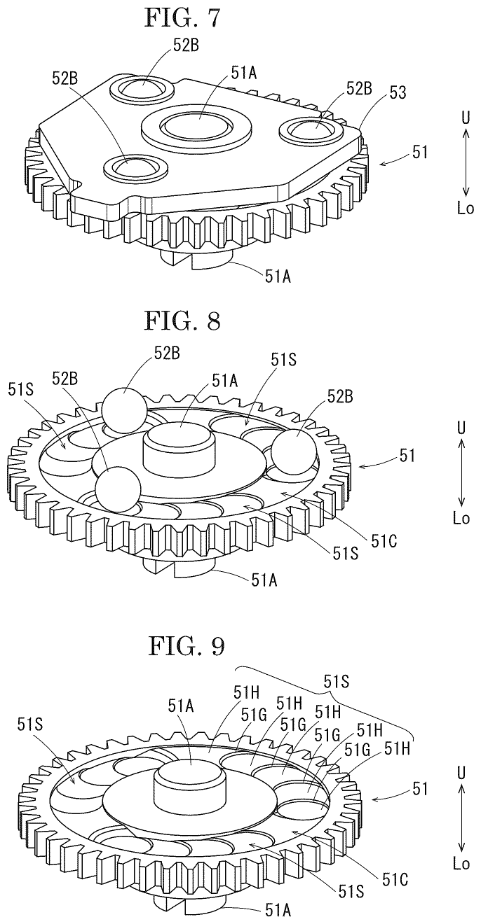

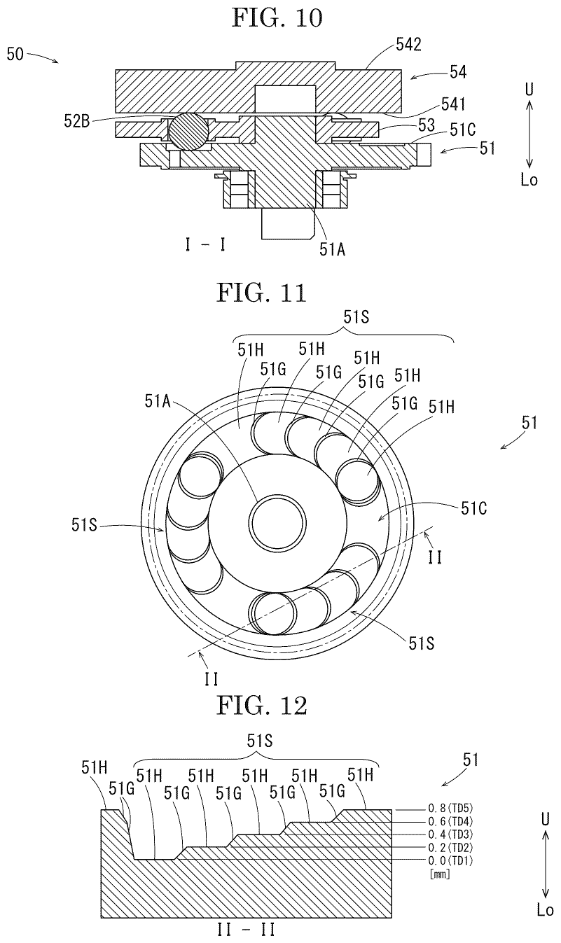

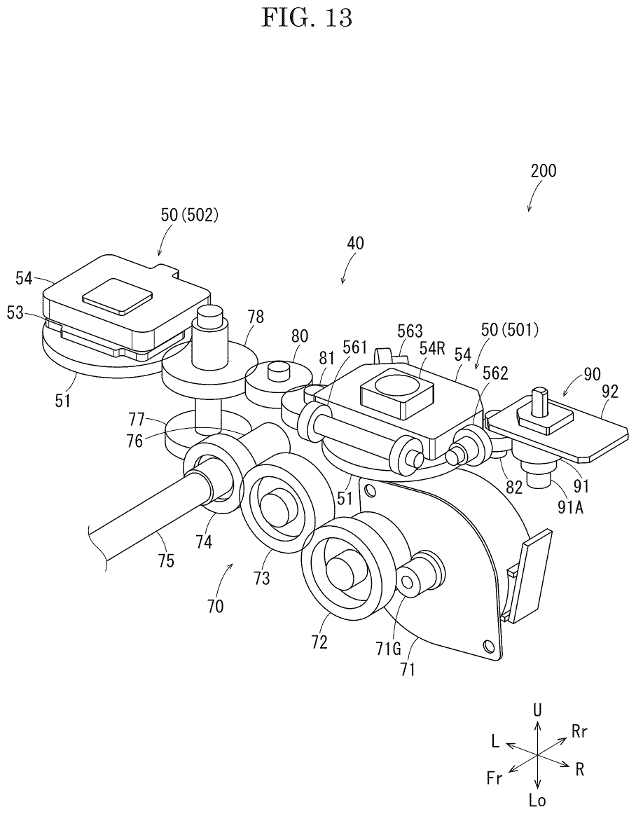

FIG. 5 is a perspective view showing the adjustment device 40. FIG. 6 is a perspective view showing a gap adjustment device 50. FIG. 7 is a perspective view showing a first rotating member 51, balls 52B, and a retainer 53. FIG. 8 is a perspective view showing the first rotating member 51 and the balls 52B. FIG. 9 is a perspective view showing the first rotating member 51. FIG. 10 is a cross-sectional view taken along the line I-I of FIG. 6. FIG. 11 is a plan view showing the first rotating member 51. FIG. 12 is a cross-sectional view taken along the line II-II of FIG. 11. FIG. 13 is a perspective view showing a detection system 200.

The head unit 11 (see FIG. 3 and FIG. 4) includes three ink jet heads 12 arranged in a staggered pattern and a frame body 11F supporting the three inkjet heads 12. At both front and rear ends of the bottom of the frame body 11F, contact portions 11C are provided at two positions spaced apart in the left-and-right direction, respectively. The contact portion 11C is, for example, a pin protruding downward. The adjustment device 40 is provided below the rear end of the frame body 11F. The adjustment device 60 is provided below the front end of the frame body 11F. The adjustment devices 40 and 60 support the head unit 11 through the contact portions 11C. The adjustment device 40 will be described below as an example.

The adjustment device 40 (see FIG. 5) has a rectangular parallelepiped housing 41 whose longitudinal direction is along the left-and-right direction. The gap adjustment device 50 (see FIG. 6) is housed in the housing 41. The gap adjustment devices 50 are provided at two positions spaced apart in the left-and-right direction. The right gap adjustment device 501 and the left gap adjustment device 502 on the left side have the same basic configuration.

[Gap Adjustment Device] The gap adjustment device 50 (see FIG. 6 to FIG. 12) includes a first shaft 51A, a first rotating member 51, an adjustment member 54, balls 52B, and a retainer 53.

[First Shaft, First Rotating Member] The first shaft 51A is supported by the housing 41 with the axil direction being along the upper-and-lower direction. The first rotating member 51 is, for example, a spur gear having 45 teeth. The upper surface (see FIG. 9, FIG. 11 and FIG. 12) of the first rotating member 51 is an example of the intersecting surface 51C intersecting the first shaft 51A. On the intersecting surface 51C, a stepped part 51S whose height changes in the circumferential direction in a stepped manner. The stepped parts 51S of the same pattern are provided at a plurality of positions in the circumferential direction on the intersecting surface 51C. In this embodiment, the stepped parts 51S having the same pattern are provided at three positions in the circumferential direction on the intersecting surface 51C.

[Stepped Part] The stepped part 51S has five steps 51H arranged in the circumferential direction and four slopes 51G connecting the two adjacent steps 51H. The five steps 51H are provided so that the height is gradually increased in the counterclockwise direction. If the height of the lowest step 51H is 0.0 mm (see FIG. 12), the height of each step 51H increases by 0.2 mm in the counterclockwise direction. The three stepped parts 51S are at equal provided intervals the in circumferential direction. In other words, the intersecting surface 51C is configured so that the same pattern of stepped height changes is repeated at 120° intervals.

[Adjustment Member] The adjustment member 54 (see FIG. 6 and FIG. 10) is formed in the shape of a rectangular parallelepiped block as a whole. The adjustment member 54 is provided above the first rotating member 51. One surface 541 (for example, the lower surface) of the adjustment member 54 faces the intersecting surface 51C of the first rotating member 51, and the other surface 542 (for example, the upper surface) of the adjustment member 54 faces the bottom of the frame body 11F (see FIG. 3 and FIG. 4). The adjustment member 54 is supported by the housing 41 and the first shaft 51A, and is slidable in the direction of the first shaft 51A.

[Ball] The balls 52B (see FIG. 7, FIG. 8 and FIG. 10) are provided between one surface 541 of the adjustment member 54 and the intersecting surface 51C. One ball 52B is arranged in each of the plurality of stepped part 51S. The three balls 52B are arranged at intervals of 120°. That is, the balls 52B are brought into contact with the steps 51H having the same height in the plurality of stepped part 51S. The balls 52B are held by the retainer 53. The retainer 53 regulates the movement of the balls 52B relative to the retainer 53. A part of the ball 52B protrudes from the upper and lower surfaces of the retainer 53. The retainer 53 is supported by the housing 41 and the first shaft 51A, and is slidable in the direction of the first shaft 51A, but the rotation around the first shaft 51A is restricted This configuration restricts the circumferential movement of the ball 52B. Since the height of the step 51H in contact with the ball 52B changes with the rotation of the first rotating member 51, the adjustment member 54 moves in the direction of the first shaft 51A together with the ball 52B and the retainer 53.

[Restriction Part] The upper portion of the gap adjustment device 50 is covered with a lid 42 (see FIG. 5). The lid 42 is provided with openings 42 above the two adjustment members 54. In the opening 42A, a part of the other surface 542 (the upper surface) of the adjustment member 54 is exposed. The adjustment member 54 of the gap adjustment device 501 is provided with a restriction part 54R (see FIG. 5 and FIG. 13). The restriction part 54R is provided on the other surface 542 of the adjustment member 54, and protrudes upward through the opening 42A of the lid 42. The restriction part 54R has a funnel-shaped or cylindrically recessed shape. The movement of the contact portion 11C in the direction crossing the first shaft 51A is restricted by accommodating the contact portion 11C of the head unit 11 in the restriction part 54R.

[Roller] The adjustment member 54 (see FIG. 13) of the gap adjustment device 501 is formed into a polygon in which the left and right rear corners of a rectangle having four sides along the front-and-rear direction and the left-and-right direction are obliquely cut when viewed from above. Rollers 561, 562, and 563 whose axial direction is along the horizontal direction are brought into contact with the front, right, and left rear side surfaces of the adjustment member 54, respectively. The rollers 561, 562, 563 regulate the lateral movement of the adjustment member 54 and guide the vertical movement.

[Driving Part] A driving part 70 (see FIG. 4 and FIG. 13) drives the gap adjustment device 50. A driving force generated by a motor 71 is transmitted to the first rotating member 51 of the gap adjustment device 502 from a driving gear 71G provided on the driving shaft of the motor 71 through an idler gear 72, an idler gear 73, an idler gear 74, a worm 76, a worm wheel 77 and a driving gear 78 in order. The driving force is transmitted from the driving gear 78 to the first rotating member 51 of the gap adjustment device 501 through an idler gear 80 and an idler gear 81 in order. The driving force is transmitted from the idler gear 74 to the adjustment device 60 via a transmission shaft 75. The motor 71 is, for example, a stepping motor.

[Control Part] The control part 2 (see FIG. 2) stores conversion information relating the sheet thickness to the rotation angle of the first rotating member 51. The control part 2 determines the rotation angle corresponding to the thickness of the sheet fed to the conveyance path 10 from the conversion information, and drives the first rotating member 51 by the driving part 70. Since the height of the step 51H in contact with the ball 52B changes with the rotation of the first rotating member 51, the adjustment member 54 moves in the direction of the first shaft 51A together with the balls 52B and the retainer 53. The head unit 11 moves in the direction of the first shaft 51A with the movement of the adjustment member 54. Thus, the gap of the head unit 11 with respect to the conveyance path 10 is adjusted according to the thickness of the sheet.

According to the gap adjustment device 50 according to the present embodiment, since the position adjustment (in this embodiment, the gap adjustment) of the adjustment member 54 can be performed by rotating the first rotating member 51, it is superior in space saving compared with a configuration in which the member having the linearly arranged steps is slid. Further, since the height of the head unit 11 can be adjusted in both the upper and lower directions by rotating the first rotating member 51 in one direction, impact due to backlash does not occur. Therefore, according to the present embodiment, the position adjustment can be performed without lowering the space saving property and durability. Further, since the loads applied to the first rotating member 51 and the adjustment member 54 are distributed to a plurality of positions, stress concentration can be suppressed. Further, since the load is distributed around the first shaft 51A, it is possible to suppress distortion of the first rotating member 51 due to a bias of the load and an error in adjustment.

[Detection System] Next, a detection system 200 (see FIG. 13) according to this embodiment will be described. The detection system 200 includes the gap adjustment device 50 (an example of the detection target device) and a detection device 90.

[Detection Device] The detection device 90 is, for example, a potentiometer. The detection device 90 includes a second shaft 91A, a second rotating member 91, and a substrate 92. The second shaft 91A is supported by the substrate 92 with the axial direction being along the upper-and-lower direction. The second rotating member 91 is, for example, a spur gear having 15 teeth. A driving force is transmitted from the first rotating member 51 of the gap adjustment device 501 to the second rotating member 91 through an idler gear 82. The substrate 92 is provided with a circuit including a variable resistor. The detection device 90 outputs a voltage corresponding to the rotation angle of the second rotating member 91.

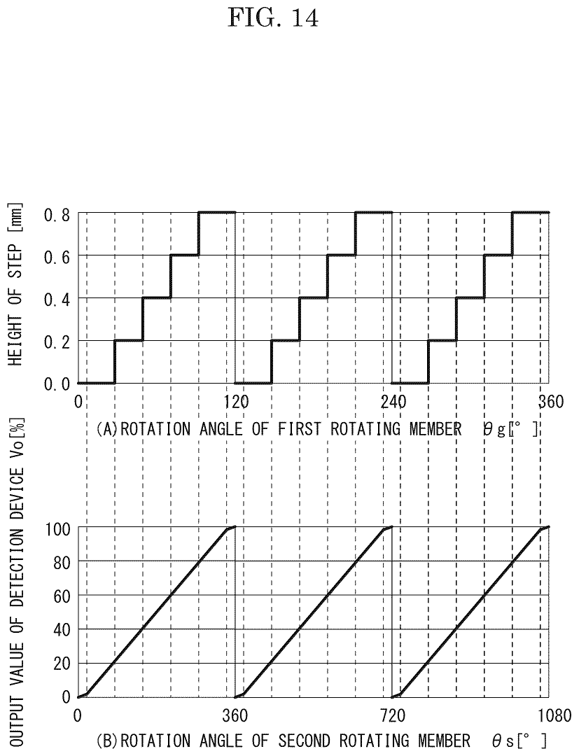

FIG. 14 is a diagram showing an operation of the detection system 200 while the first rotating member 51 rotates once. (A) in FIG. 14 shows the relationship between the rotation angle θg [′] of the first rotating member 51 and the height [mm] of the step 51H in contact with the ball 52B. The horizontal axis of (A) in FIG. 14 represents the rotation angle when the first rotating member 51 is driven in the clockwise direction as viewed from above. The gap adjustment device 50 repeats the operation corresponding to the rotation angle θg [°] of the first rotating member 51 every time the first rotating member 51 rotates by 1/N (N=3). In this operation, the height of the step 51H in contact with the ball 52B increases by one step from the lowest step 51H to the highest step 51H of the stepped part 51S.

(B) in FIG. 14 shows the relationship between the rotation angle θs [°] of the second rotating member 91 and the output value Vo [%] of the detection device 90. Since the idler gear 82 is disposed between the first rotating member 51 and the second rotating member 91, the second rotating member 91 rotates in the same direction as the first rotating member 51. That is, the horizontal axis of (B) in FIG. 14 represents the rotation angle when the second rotating member 91 is driven in the clockwise direction as viewed from above. The vertical axis of (B) in FIG. 14 represents the ratio of the output value Vo [%] of the detection device 90 to the maximum value as a percentage. Every time the first rotating member 51 rotates by 1/N, the second rotating member 91 rotates once. Every time the second rotating member 91 rotates once, the output value Vo [%] of the detection device 90 is repeatedly monotonically increased from the minimum value to the maximum value in accordance with the rotation angle θs [°] of the second rotating member 91. Note that the output value Vo [%] of the detection device 90 may be configured to decrease monotonically.

As shown in FIG. 14, the height of the step 51H in contact with the ball 52B while the first rotating member 51 rotates by 1/N is related to the output value Vo [%] of the detection device 90 while the second rotating member 91 rotates once. With this configuration, the height of the step 51H in contact with the ball 52B is determined from the output value Vo [%] of the detection device 90. The control part 2 determines whether the height of the step 51H in contact with the ball 52B corresponds to the thickness of the sheet, and if the height of the step 51H corresponds to the thickness of the sheet, executes the image forming job. When the height of the step 51H is lower than the height corresponding to the thickness of the sheet, the control part 2 drives the first rotating member 51 in the clockwise direction by one step to redetermine the height of the step 51H. On the other hand, if the height of the step 51H is higher than the height corresponding to the thickness of the sheet, the control part 2 drives the first rotating member 51 in the counterclockwise direction by one step to redetermine the height of the step 51H.

In the present embodiment, since the operating amount of the first rotating member 51 for every 1/N rotation is related to the output value Vo [%] of the detection device 90 for every one rotation, the resolution of the detection device 90 is maximized. Therefore, the operating amount of the detection target device can be detected with high accuracy.

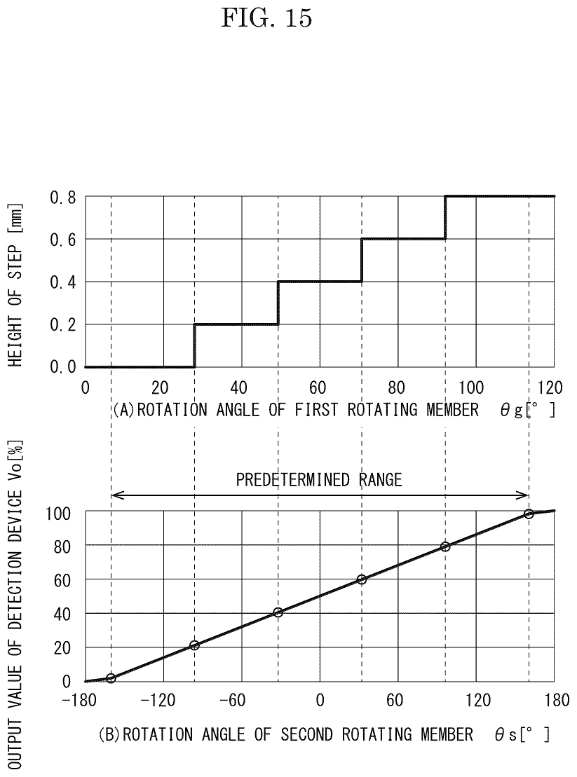

FIG. 15 is a diagram showing the operation of the detection system 200 while the first rotating member 51 rotates 1/N (N=3). That is, (A) in FIG. 15 is a diagram in which the section from θg=0 to 120 degrees in (A) in FIG. 14 is enlarged in the horizontal axis direction, and FIG. 15B is a diagram in which the section from θs=0 to 360 degrees in (A) in FIG. 14 is enlarged in the horizontal axis direction. In (B) in FIG. 15, the horizontal axis is replaced by −180 to 180 degrees.

As shown in (B) in FIG. 15, the output value Vo [%] of the detection device 90 (potentiometer) has a lower resolution in the vicinities of the minimum value and the vicinity of the maximum value because the gradient is smaller than in the other sections. Further, as shown in (B) in FIG. 14, since the output value Vo [%] changes discontinuously from the maximum value to the minimum value at the timing of the interval of each rotation of the second rotating member 91, the height of the step 51H may be misrecognized.

On the other hand, in the present embodiment, the range of the output value Vo [%] of the detection device 90, excluding the section where the output value Vo [%] changed discontinuously within the entire range from the minimum value to the maximum value, in other words, the predetermined range in which the detection accuracy is guaranteed (see (B) in FIG. 15) is allocated to the region corresponding to 1/N rotation of the first rotating member 51, so that it is possible to prevent misrecognition of the operating amount of the first rotating member 51. Therefore, according to the present embodiment, the operating amount of the detection target device can be detected with high accuracy.

[Backlash Correction] Next, backlash correction according to the present embodiment will be described. As described above, the height of the step 51H in contact with the ball 52B is obtained from the output value Vo [%] of the detection device 90. The control part 2 determines whether the height of the step 51H in contact with the ball 52B corresponds to the thickness of the sheet, and if the height of the step 51H corresponds to the thickness of the sheet, executes the image forming job. If the height of the step 51H is lower than the height corresponding to the thickness of the sheet, the control part 2 drives the first rotating member 51 in the clockwise direction by one step to redetermine the height of the step 51H. On the other hand, if the height of the step 51H is higher than the height corresponding to the thickness of the sheet, the control part 2 drives the first rotating member 51 in the counterclockwise direction by one step to redetermine the height of the step 51H.

However, when the rotation direction of the first rotating member 51 is changed, a phase shift occurs in the output value Vo [%] of the detecting device 90 due to backlash of the gear train (idler gear 72, idler gear 73, idler gear 74, worm 76, worm wheel 77, drive gear 78, idler gear 80, and idler gear 81) disposed between the driving gear 71G of the motor 71 and the first rotating member 51.

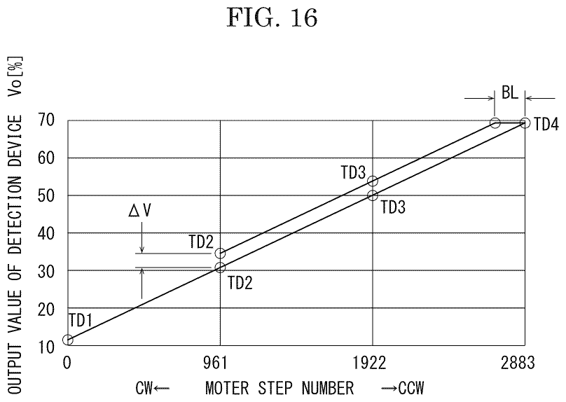

FIG. 16 is a diagram showing the phase shift due to backlash when the rotation direction of the first rotating member 51 is changed. Here, TD1, TD2, TD3, TD4, and TD5 (see FIG. 12) are symbols for identifying the height of the steps 51H. In the example shown in FIG. 16, the phase shift is measured by rotating the first rotating member 51 from TD1 to TD4 through TD2 and TD3, and then rotating the first rotating member 51 in reverse through TD3 to TD2. In this case, since the backlash BL of the gear train occurs in the process of returning from TD3 through TD4 to TD3, during the period from when the motor 71 is reversed until the backlash BL is eliminated, the change of the output value Vo [%] is delayed, and a phase shift ΔV [%] occurs in the output value Vo [%] of the detection device 90 when it returns to TD2.

Therefore, the control part 2 calculates the number of motor steps (hereinafter, it is referred to as the number of backlash correction steps) corresponding to the phase shift ΔV [%]. In this example, since 961 [steps] of the number of motor steps corresponds to 20 [%] of the output value Vo [%], the number of backlash correction steps is calculated by equation (1).

Number of backlash correction steps=961×ΔV/20 (1)

By adding the reverse rotation of the motor 71 by the number of backlash correction steps calculated by Equation (1), the output value Vo [%] of the detection device 90 is corrected.

The above example shows a process from the initial state at TD1 turned back at TD4, but in order to improve the accuracy of the correction, it is desirable to take a longer process for measuring the phase shift. Specifically, the initial state is preferably set at TD1, and the turnaround point of the process is preferably TD4 rather than TD3, and more preferably TD5 rather than TD4.

The detection system 200 according to the present embodiment described above includes: the detection object device (the gap adjustment device 50) including the first rotating member 51 rotating around the first shaft 51A; the detection device 90 including the second rotating member 91 rotating around the second shaft 91A by the driving force transmitted from the first rotating member 51 through the gear train (idler gear 72, idler gar 73, idler gear 74, worm 76, worm wheel 77, drive gear 78, idler gear 80, and idler gear 81), wherein the output value Vo [%] monotonically increases or decreases in accordance with the rotation angle θs [°] of the second rotating member 91; and the control part 2 which calculates the driving amount of the first rotating member 51 for correcting the output value Vo [%] of the detection device 90 from the phase shift ΔV [%] of the output value Vo [%] of the detection device 90 when the rotation direction of the first rotating member 51 is changed. According to this configuration, the degradation of detection accuracy due to backlash of the gear train can be suppressed.

In addition, according to the detection system 200 according to the present embodiment, the control part 2 calculates the driving amount of the first rotating member 51 for correcting the output value Vo [%] of the detecting device 90 from the phase shift ΔV [%] of the output value Vo [%] of the detection device 90 when the rotational direction of the first rotating member 51 is changed and the proportional relationship between the driving amount of the first rotating member 51 and the output value Vo [%] of the detection device 90. According to this configuration, the degradation of detection accuracy due to backlash of the gear train can be suppressed.

In addition, according to the detection system 200 according to the present embodiment, the first rotating member 51 has the intersecting surface 51C intersecting the first shaft 51A, and the detection object device includes the stepped part 51S provided on the intersecting surface 51C and whose height is changed in a stepped manner in the circumferential direction, the adjustment member 54 which faces the intersecting surface 51C and is movable in the direction of the first shaft 51A, and the balls 52B which are disposed between the adjustment member 54 and the intersecting surface 51C and restricted in movement in the circumferential direction, wherein the stepped parts 51S having the same pattern are provided at N positions (N is an integer greater than or equal to 2) in the circumferential direction on the intersecting surface 51C, one ball 52B is arranged at each of the stepped parts 51S at the N positions, and the balls 52B are in contact with the steps 51H having the same height of the stepped parts 51S at the N positions. According to this configuration, the height of the step 51H in contact with the ball 52B can be detected with high accuracy.

According to the detection system 200 according to the present embodiment, every time the first rotating member 51 rotates by 1/N, the detection target device repeats the operation corresponding to the rotation angle θg [°] of the first rotating member 51, and every time the second rotating member 91 rotates once, the output value Vo [%] of the detection device 90 repeats a monotonic increase or a monotonic decrease corresponding to the rotation angle θs [°] of the second rotating member 91. According to this configuration, the operating amount of the detection target device can be detected with high accuracy.

According to the detection system 200 according to the present embodiment, the detection device 90 is a potentiometer. According to this configuration, the detection system 200 can be configured inexpensively.

According to the detection system 200 according to the present embodiment, the first rotating member 51 and the second rotating member 91 are the gears. According to this configuration, it is possible to eliminate the error of the operating amount due to the sliding of the first rotating member 51 and the second rotating member 91.

The inkjet recording apparatus 1 according to the present embodiment includes the head unit 11 which includes one or more inkjet heads 12 and is in contact with the adjustment member 54, and the detection system 200, and the control part 2 controls the detection target device according to the operating amount of the detection target device detected by the detection system 200. According to this configuration, the gap adjustment of the head unit 11 can be performed with high accuracy.

The above embodiments may be modified as follows.

Although the first rotating member 51 is a spur gear in the above-described embodiment, the first rotating member 51 may be configured to be rotationally driven around the first shaft 51A, and the first rotating member 51 itself may not be a gear. For example, a gear may be joined to the lower surface of the disc-shaped first rotating member 51 (not shown). The same applies to the second rotating member 91.

A means other than a gear may be used for transmitting the driving force from the first rotating member 51 to the second rotating member 91. For example, the first rotating member 51 and the second rotating member 91 may be formed of a magnetic gear.

In the above embodiment, the number of teeth of the first rotating member 51 is 45 and the number of teeth of the second rotating member 91 is 15, but these numbers of teeth are only one example, and if the ratio of the number of teeth of the first rotating member 51 to the number of teeth of the second rotating member 91 is N:1 (N is an integer greater than or equal to 2), the number of teeth may be different from these numbers.

In place of the ball 52B of the above embodiment, a projection 52P (not shown) may be provided which projects from one surface 541 of the adjustment member 54 and is in contact with the intersecting surface 51C. In this case, the retainer 53 is unnecessary. One projection 52P is arranged in each of the plurality of stepped parts 51S, and the projections 52P are brought into contact with the steps 51H having the same height in the plurality of stepped parts 51S. In this configuration, the height of the step 51H in contact with the projection 52P changes with the rotation of the first rotating member 51, so that the adjustment member 54 moves in the direction of the shaft 51A.

Although the detection device 90 is a potentiometer in the above embodiment, the detection device 90 may be an absolute rotary encoder, for example.

In the above embodiment, the detection system 200 is applied to the gap adjustment of the head unit 11, but the detection system 200 is applicable to a variety of applications. For example, the detection system 200 may be used to position a variety of movable parts, such as a shading plate for an image reading device or a separation pawl for separating a sheet from an electrophotographic fixing roller.

In the above embodiment, the tooth ratio of the first rotating member 51 to the second rotating member 91 is N:1, but the backlash correction described above can be applied even when the tooth ratio of the first rotating member 51 to the second rotating member 91 is not N:1. In the above embodiment, the detection device 90 is a potentiometer or an absolute rotary encoder, but the backlash correction can be applied even when the detection device 90 is an incremental rotary encoder.

1. A detection system comprising:
a detection target device which is provided with a first rotating member rotating around a first shaft;
a detection device which is provided with a second rotating member rotating around a second shaft by a driving force transmitted from the first rotating member through a gear train, and whose output value monotonically increases or decreases according to a rotation angle of the second rotating member; and
a control part which calculates a driving amount of the first rotating member for correcting an output value of the detection device from a phase shift of an output value of the detection device when a rotation direction of the first rotating member is changed.

2. The detection system according to claim 1, wherein,
the control part calculates the driving amount of the first rotating member for correcting an output value of the detection device from a phase shift of an output value of the detection device when a rotation direction of the first rotating member is changed and a proportional relationship between a driving amount of the first rotating member and an output value of the detection device.

3. The detection system according to claim 1, wherein,
the first rotating member has an intersecting surface intersecting the first shaft;
the detection target device includes:
a stepped part which is provided on the intersecting surface and whose height is changed in a stepped manner in a circumferential direction;
an adjustment member which faces the intersecting surface and is movable in a direction of the first shaft;
balls disposed between the adjustment member and the intersecting surface and restricted in movement in the circumferential direction, or projections projecting from the adjustment member and in contact with the intersecting surface, and
the stepped parts having the same pattern are provided at N positions (N is an integer greater than or equal to 2) in the circumferential direction on the intersecting surface,
one ball or one projection is arranged in each of the stepped parts at N positions, and
the balls or the projections are in contact with steps of the same height of the stepped parts at N positions.

4. The detection system according to claim 1, wherein,
the detection object device repeats an operation corresponding to a rotation angle of the first rotating member every time the first rotating member rotates by 1/N, and
an output value of the detection device repeats monotonic increase or monotonic decrease in accordance with a rotation angle of the second rotating member every time the second rotating member rotates once.

5. The detection system according to claim 1, wherein,
the detection device is a potentiometer.

6. The detection system according to claim 1, wherein,
the first rotating member and the second rotating member are gears.

7. An inkjet recording apparatus comprising:
a head unit which includes one or more inkjet heads and is in contact with the adjustment member, and
the detection system according to claim 3, wherein
the control part controls the detection target device according to an operating amount of the detection target device detected by the detection system.
